(19) United States
(12) Patent Application Publication
(10) Pub. No.: US 2007/0211624 A1
(43) Pub. Date: Sep. 13, 2007

(54) COMMUNICATION DEVICE, RADIO COMMUNICATION ARRANGEMENT AND METHOD FOR TRANSMITTING INFORMATION

(75) Inventors: Andreas Schmidt, Braunschweig (DE); Norbert Schwagmann, Braunschweig (DE); Martin Hans, Bad Salzdetfurth (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/683,290

(22) Filed: Mar. 7, 2007

(30) Foreign Application Priority Data
Mar. 7, 2006 (DE) 10 2006 010 513.3

(51) Int. Cl. H04J 3/14

(52) U.S. Cl. 370/225

(57) ABSTRACT

A radio communication device having a first radio transmission unit for transmitting information according to a first radio transmission technology as well as a second radio transmission unit for transmitting information according to a second radio transmission technology. In addition, the radio communication device has a selection unit for selecting the first radio transmission unit or the second radio transmission unit or both radio transmission units for transmitting information depending on at least one predefinable radio transmission technology selection criterion.

### CROSS-REFERENCE TO RELATED APPLICATION

This application claims priority to German Patent Application Ser. No. 10 2006 010 513.3, which was filed Mar. 7, 2006, and is incorporated herein by reference in its entirety.

### TECHNICAL FIELD

The invention relates to a radio communication device, a radio communication arrangement and a method for transmitting information from a first radio communication device to a second radio communication device.

### BACKGROUND OF THE INVENTION

The local networking of small mobile electronic devices using close-range radio, for example by means of Bluetooth, requires increasingly higher data rates. For this reason, methods are desirable which permit efficient use of communication resources in close-range radio.

### BRIEF DESCRIPTION OF THE FIGURES

In the drawings:

FIG. 1 shows a radio communication arrangement according to an exemplary embodiment of the invention;

FIG. 2 shows a block diagram in which the protocol layers are represented according to a Bluetooth communication protocol;

FIG. 3 shows graphs in which the differences between OFDM and FDM are illustrated;

FIG. 4 shows a block diagram in which a communication layer structure according to an exemplary embodiment of the invention is illustrated;

FIG. 5 shows a communication layer structure according to another exemplary embodiment of the invention; and

FIG. 6 shows a flowchart in which the method steps of an exemplary embodiment of the invention are illustrated.

### DETAILED DESCRIPTION

Nowadays, what is referred to as Bluetooth technology is becoming increasingly established for the local networking of small mobile electronic devices such as, for example, mobile radio telephones or what are referred to as personal digital assistants (PDAs), as well as computers and peripheral devices, for example a computer mouse or a keyboard. Bluetooth is an industrial standard for the wireless radio networking of devices over a relatively short distance. In recent times the use of Bluetooth technology has also become more widespread in the automobile industry. Typically, in the automobile industry the acoustic and/or visual input devices and output devices or operator control elements which are permanently integrated in the car, for example a microphone, loudspeaker, display, keys etc., are coupled in a wireless fashion to a mobile radio telephone which itself no longer has to be operated in order to make telephone calls and can remain in the user's coat pocket, for example, during the entire journey.

There is a continuous need for a data transmission alternative for a Bluetooth device with a relatively high data transmission rate. While the field of use of the Bluetooth technology is usually restricted to the transmission of small quantities of data, the need for more rapid data transmission in close-range radio is becoming greater, for example in order to synchronize quickly mobile digital playback devices for music files and video files, for example in an MP3 player, an iPod device etc. with multimedia databases at home in a person's living room.

Within the scope of the standardization committee which develops the Bluetooth communication standard it was proposed to use ultra wideband radio transmission technologies, specifically the orthogonal frequency-division multiplex (OFDM) transmission method or the direct sequence spread spectrum (DSSS) transmission method which permit the desired data rates to be reached.

According to one exemplary embodiment of the invention, a radio communication device is provided which has a first radio transmission unit for transmitting information according to a first radio transmission technology and a second radio transmission unit for transmitting information according to a second radio transmission technology. Furthermore, the radio communication device has a selection unit for selecting the first radio transmission unit or the second radio transmission unit or both radio transmission units for transmitting information depending on at least one predefinable radio transmission technology selection criterion.

According to another exemplary embodiment of the invention, a radio communication arrangement is provided which has a radio communication device such as what is described above, and a rule database for storing at least one rule according to which the at least one radio transmission technology in the radio communication device is selected.

According to another exemplary embodiment of the invention, a method for transmitting information from a first radio communication device to a second radio communication device is provided, in which method at least one radio transmission technology is selected from a plurality of radio transmission technologies for transmitting information, said selection being carried out depending on at least one predefinable radio transmission technology selection criterion.

According to one exemplary embodiment of the invention, a flexible adaptation of the radio transmission technology used to the current transmission situation is made possible in the way described above, depending on the at least one radio transmission technology selection criterion which is respectively taken into account.

Exemplary embodiments are illustrated in the figures and are explained in more detail below.

In the figures, insofar as appropriate, similar or identical elements are provided with identical reference symbols. The figures are not true to scale.

According to one exemplary embodiment of the invention, the selection unit is configured to select the first radio transmission unit or the second radio transmission unit or both radio transmission units for transmitting information depending on at least one predefinable radio transmission technology selection criterion which is measured or is to be measured.

At least one of the radio transmission technologies can be a radio access technology, for example a mobile radio access technology or a wireless local network access technology (wireless local area network, WLAN).

According to one exemplary embodiment of the invention, at least one of the radio transmission units is configured to transmit information according to one of the following radio communication technologies:
wireless local area network technology (WLAN), for example according to the radio communication standard IEEE 802.11 or according to HIPERLAN, HIPERACCESS, HIPERLINK,
a technology according to a second-generation mobile radio communication standard, for example according to the global system mobile communication standard (GSM), according to the enhanced data rate for GSM evolution communication standard (EDGE) or according to the general packet radio service communication standard (GPRS),
a technology according to a third-generation mobile radio communication standard, for example according to the universal mobile telecommunications system communication standard (UMTS), the code-division multiple access 2000 communication standard (CDMA 2000) or according to the freedom of mobile multimedia access communication standard (FOMA).

According to one exemplary embodiment of the invention, at least one radio transmission unit is configured to transmit information according to a radio close-range transmission technology, wherein the radio close-range transmission technology has, for example, a radio transmission range of a maximum of 5 km, for example of a maximum of 2 km, for example of a maximum of 1.5 km.

Furthermore, according to one embodiment of the invention there is provision for at least one of the radio transmission units to be configured to transmit information according to a Bluetooth transmission technology, in other words according to the Bluetooth communication standard.

Furthermore, at least one of the radio transmission units can be configured to transmit information according to one of the following transmission technologies:
Bluetooth physical communication layer transmission technology,
frequency-type-division multiplex (for example frequency-division multiplex),
time-division multiplex,
broadband radio transmission technology,
ultra wideband radio transmission technology such as, for example, the transmission technology orthogonal frequency-division multiple access (OFDMA) or a frequency spread method, for example the direct sequence spread spectrum (DSSS) method.

According to one exemplary embodiment of the invention, the radio transmission unit is a unit of the physical communication layer.

Furthermore, according to one exemplary embodiment of the invention, the selection unit is a unit of a communication layer which is higher than the physical layer, for example in the sense of the communication layer reference model Open System Interconnection (OSI) of the International Standardization Organization (ISO).

The selection unit can be, for example, a unit of the following communication layers:
data link layer,
transport layer,
switching layer, or
network layer.

Furthermore, the selection unit can be configured for the dynamic distribution of the information over a plurality of radio transmission units, while at least one radio communication link is set up by means of a radio transmission technology. In other words, this embodiment means that during an existing radio communication link, for example physically measurable variables are measured continuously or at predefinable times or when specific predefinable events occur, and said variables are evaluated in terms of the at least one radio transmission technology selection criterion, and depending on the result of the evaluation it is decided whether the radio communication link is continued with the same radio transmission technology with which it has already been set up, whether an additional radio transmission technology is to be added, or whether another radio transmission technology is to be selected, on which other radio transmission technology the radio communication link is then based after the switching-over process, without the radio communication link having to be interrupted or released in a way which is noticed by the user.

The predefinable radio transmission technology selection criterion can be one of the following criteria:
a criterion which describes properties of a channel, for example of a physical channel, a transport channel or a logic channel, for example of the radio communication link,
a criterion which describes properties of the radio communication device, for example the battery charge state of a battery of the radio communication device,
a criterion which describes properties outside the radio communication device, for example a speed with which the radio communication device is moved, for example relatively in relation to the receiver of the transmitted information within the scope of the radio communication link which has been set up,
a criterion which describes requirements of an application for which the information is to be transmitted.
   In this context it is possible to provide criteria which describe QoS (quality of service) requirements of an application, such as the maximum permissible delay time or the minimum necessary data rate.

Alternatively, a radio transmission technology selection criterion which describes the radio communication device itself can be a connection or the connecting of at least one peripheral device or of another communication device to the radio communication device, generally the occurrence of a predefinable event.

According to one exemplary embodiment of the invention, the radio communication device has a rule memory for storing at least one rule according to which the at least one radio transmission technology is selected.

Furthermore, in the radio communication device it is possible to provide at least one measuring device for measuring physical quantities whose values are to be compared with the predefinable radio transmission technology selection criterion, in other words which are to be evaluated with respect to the radio transmission technology selection criterion.

According to one exemplary embodiment of the invention, a plurality of measuring devices for measuring physical variables can be provided, the values of which devices are to be compared with the predefinable radio transmission technology selection criterion.

The measuring devices can be provided at least partially in different communication layers and measure physical variables which are correspondingly provided in the respective communication layers or compare the measured values with the radio transmission technology selection criterion which is then referred to this communication layer.

It is possible to use any desired radio transmission technology selection criteria together, and these are then logically combined by logic AND operations and/or logic OR operations to form a radio transmission technology selection criterion, it being possible to refer the individual criteria to variables of different communication layers.

According to one embodiment of the invention, in each of the following communication layers at least one measuring device is provided for measuring physical variables which represent information from the respective communication layer:
physical layer,
data link layer,
transport layer,
switching layer.

The term “measuring device” is intended to be interpreted within the scope of this description as meaning that it can be read both on sensors for sensing qualitative states and on sensors for sensing quantitative physical variables. In particular, sensors which are located in the application layer and are capable of being able to sense QoS parameters are included under the term “measuring device” as it is used here and in the text which follows.

Furthermore, at least one control unit can be provided for controlling the at least one measuring device and additionally or alternatively a control unit for controlling the selection unit can be provided, in which case the control unit for controlling the selection unit can be integrated in the selection unit itself or else can form a common control unit with the control unit for controlling the at least one measuring device.

The selection unit can also be configured in such a way that while a radio communication link is set up, it is possible to switch over to at least one other radio transmission technology depending on the result of the comparison with the radio transmission technology selection criterion.

In one embodiment of the method for transmitting information from a first radio communication device to a second radio communication device it is possible to provide for information to be transmitted according to the selected radio transmission technology.

According to one exemplary embodiment of the invention, the method also comprises:
transmission of information according to a first radio transmission technology,
selection of at least one second radio transmission technology from a plurality of radio transmission technologies for transmitting information depending on at least the predefinable radio transmission technology selection criterion,
transmission of information according to the first radio transmission technology and/or according to the second radio transmission technology.

Furthermore, a computer program product is made available which, if it is executed, for example executed by a processor of the radio communication device, comprises a selection of at least one radio transmission technology from a plurality of radio transmission technologies for transmitting information depending on at least one predefinable radio transmission technology selection criterion.

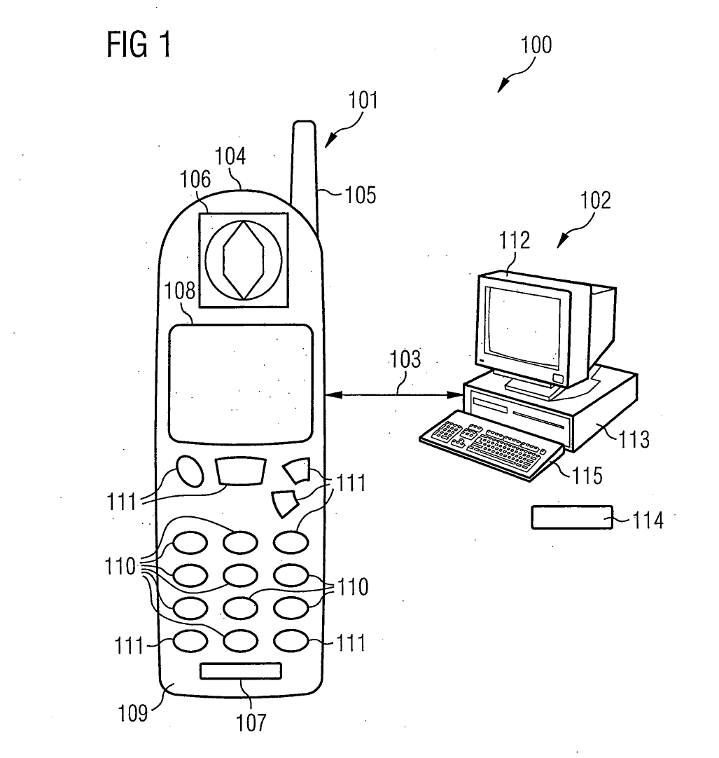

FIG. 1 shows a radio communication arrangement 100 according to an exemplary embodiment of the invention.

The radio communication arrangement 100 has a mobile radio communication terminal 101 and a personal computer 102 as radio communication devices.

It is assumed that the mobile radio communication terminal 101 and the personal computer 102 have a communication connection to one another by means of a Bluetooth communication link, symbolized in FIG. 1 by means of an arrow 103.

The mobile radio communication terminal 101 has a housing 104 in which an antenna 105 is provided, or to which an antenna 105 is attached. In addition, the mobile radio communication terminal 101 has a loudspeaker 106, a microphone 107 and a display 108. Furthermore, a keypad 109 is provided with a plurality of numerical keys 110 and function keys 111 such as, for example, a function key for setting up a mobile radio communication link, a function key for releasing a mobile radio communication link and a function key for switching off the mobile radio communication terminal 101.

The personal computer 102 has a screen 112 which is connected to the computer 113 of the personal computer 102 by means of a corresponding communication link. In addition, a computer mouse 114 and a keyboard 115 are coupled to the personal computer 102.

It is to be noted that in an alternative embodiment of the invention any two or more radio communication devices may be provided in the radio communication arrangement 100, basically any number of radio communication devices. Alternatively, a radio communication device may be, for example, a personal digital assistant, a workstation, a mass storage device, a music system, a beamer or else a computer mouse, a keyboard or any other desired mobile device which can be set up to transmit radio information according to, for example, a Bluetooth information transmission technology, alternatively according to one of the other radio transmission technologies described in the text which follows.

For example, an alternative radio communication arrangement 100 can be a mobile radio communication terminal 101 and a radio communication device which is installed in a motor vehicle, in which case, for example, the acoustic and/or visual input devices and output devices or operator control elements such as, for example, a microphone, loudspeaker, a display, a key or a plurality of keys etc., which are permanently integrated in the motor vehicle, for example in a car, are coupled in a wireless fashion to the mobile radio communication terminal 101 which no longer has to be operated itself, for example in order to make a call, and can remain, for example, in the coat pocket of a user of the mobile radio communication terminal 101 during the entire journey.

Bluetooth communication networks, usually have an ad hoc character, i.e. the Bluetooth devices, find one another and connect to one another automatically and spontaneously as soon as they have come within radio range of one another. The Bluetooth communication networks are also referred to as wireless personal area networks (WPAN). According to one exemplary embodiment of the invention, a Bluetooth radio communication device can at the same time maintain up to seven Bluetooth radio communication links to other Bluetooth communication terminals, the Bluetooth communication devices having to share the available bandwidth with one another (this is also referred to as shared medium). If there are more than two Bluetooth devices which are connected to one another by means of Bluetooth, such a communication network is also referred to as a Bluetooth piconet. Bluetooth supports the transmission of voice information and data equally well. For the sake of simplification, the expression “in order to transmit information” is also used below and is intended to mean both the transmission of voice information and of data such as, for example, video data, music files (audio data), still image data, textual data etc. The transported information which is to be transmitted can also be encrypted according to Bluetooth.

According to this exemplary embodiment of the invention, a microprocessor chip, referred to as the Bluetooth module, is provided in every radio communication device which is configured to communicate according to a Bluetooth transmission technology. The Bluetooth module requires little energy for operation, provides integrated safety mechanisms and is relatively inexpensive to manufacture. As a result, it can be used in a wide range of electronic devices. According to one exemplary embodiment of the invention, the Bluetooth module is composed of a radio frequency part (RF part) and a baseband controller which constitutes the interface with the host system, for example, the PC, laptop or some other mobile radio communication terminal, for example a mobile radio telephone. The details of this will be explained in more detail in the text which follows.

The Bluetooth communication standard currently defines the following three transmission power classes:
a first transmission power class with a transmission power of 1 mW (0 dBm),
a second transmission power class with a transmission power of 2.5 mW (4 dBm), and
a third transmission power class with a transmission power of 100 mW (20 dBm).

According to the three transmission power classes, ranges from 10 m to 100 m transmission distance are made possible with the current Bluetooth standard, as is illustrated in the following table 1:

TABLE 1
Bluetooth power classes

| | | Minimum range over line-of- |
|---|---|---|
| Class | Maximum transmission power | sight connection |
| 1 | 100 mW/20 dBm | 100 m |
| 2 | 2.5 mW/4 dBm | 20 m |
| 3 | 1 mW/0 dBm | 10 m |

The power consumption of the Bluetooth module is low; it is approximately 0.3 mA in the standby mode and otherwise reaches a maximum of 140 mA. The reception parts have a sensitivity of at least −70 dBm and operate with a channel width of 1 MHz.

The Bluetooth communication devices transmit in the license-free ISM frequency band (ISM: Industrial, Scientific, Medical), i.e. in a frequency range between 2.402 GHz and 2.480 GHz. The Bluetooth communication devices are allowed to operate throughout the world without approval. However, noise can be caused, for example, by WLAN communication networks, cordless (wireless) telephones, garage door openers or microwave ovens, which also operate in the ISM frequency band.

In order to obtain sufficient robustness with respect to noise, according to this exemplary embodiment of the invention a frequency hopping method is used in which the frequency band is divided into a plurality of frequency stages, for example 79 frequency stages with a frequency interval of 1 MHz, which are changed very frequently, for example up to 1600 times per second, in which context it is to be noted that packet types in which the frequency stages are not changed so frequently are also provided. At the lower end and at the upper end of the frequency range there is in each case a frequency band as a safety interval (also referred to as a guard band) from adjacent frequency ranges. In a Bluetooth communication device according to one exemplary embodiment of the invention which uses the Bluetooth version 1.2 (or an earlier Bluetooth version), a data transmission rate of 723.2 kbit/s can be achieved theoretically for downloading (net in download) with 57.6 kbit/s simultaneously during uploading (net in upload). In a Bluetooth communication device according to another exemplary embodiment of the invention in which the Bluetooth version 2.0 is used, an expansion which is known by the name EDR (Enhanced Data Rate) is provided, which permits a maximum data transmission rate which is approximately three times as high, that is to say a data transmission rate of approximately 2.2 Mbit/s when downloading information onto the radio communication device (net in download).

According to one exemplary embodiment of the invention, there is provision for the theoretical ranges of the Bluetooth communication devices described in Table 1 and above to be increased further from 10 m to 100 m (depending on the power class) so that, for example, a Bluetooth-enabled mobile radio telephone can still be contacted as a radio communication device by a personal computer by means of a correspondingly modified Bluetooth USB dongle by using a directional radio antenna with visual contact even from approximately 1.5 km away.

As soon as a Bluetooth communication device is put into operation, the individual Bluetooth controllers of the Bluetooth communication devices which are in each case located in the range of the other Bluetooth communication device will identify one another within two seconds by means of an individual and unmistakable 48 bit-long serial number. In the standby mode, unconnected Bluetooth communication devices listen into messages from possible opposing stations at time intervals of 1.28 seconds and in doing so check, for example, 32 hop frequencies. A Bluetooth communication link can start from any Bluetooth communication device which as a result becomes a master communication device. The contact with the slave communication devices is established by an inquiry message and then by a page message if the hardware address of the respective Bluetooth communication devices is unknown. If the hardware address of the Bluetooth communication devices is known, the first step is omitted. In the so-called page state, according to one exemplary embodiment of the invention the master communication devices are 16 identical page telegrams on 16 different hopping frequencies which are intended for the slave communication devices.

Then, the stations, in other words the Bluetooth communication devices, are in the “connected” state. On average, according to one exemplary embodiment of the invention a communication link setup is achieved within 0.6 seconds.

If there is no data to be transmitted between the Bluetooth communication devices when a Bluetooth communication link is set up, the master communication device can place its opposing slave stations, i.e. the connected slave communication devices, in a hold mode in a piconet, in order to save current. Further states for saving current, which are suitable in particular for applications in mobile communication terminals such as, for example, a mobile radio telephone, are, according to one exemplary embodiment, what is referred to as the SNIFF mode and what is referred to as the PARK mode. In the SNIFF mode, a slave communication device operates in a reduced cycle, while in the PARK mode a Bluetooth communication device remains synchronized but does not participate in the data traffic.

The Bluetooth baseband is a combination of line switching and packet switching.

According to one exemplary embodiment of the invention, two different connection types are provided within the scope of the Bluetooth data transmission:

1 . Synchronous Connection Oriented (SCO) Connection Type:

The synchronous, connection-oriented communication creates a symmetrical, line-switched point to point communication link between a master communication device and a slave communication device. The master communication device reserves time slots at regular intervals for the transmission of information; the master communication device can transmit information, basically any desired data, in a fixed time slot (referred to as the SCO intervals, TSCO), to the slave communication device, and the slave communication device can transmit its data or its information in the following time slot.
A master communication device can support up to three SCO communication links to one or more slave communication devices.
A slave communication device can maintain up to three SCO communication links to one master communication link or at maximum two SCO communication links to different master communication devices.
SCO communication links are aimed at insuring efficient voice transmission. Each SCO communication link can transmit voice signals at 62 kbit/s. With SCO communication links there is no checking of the data integrity. If data is lost during the transmission, repeated transmission does not take place since this would mean a delay for the following data packets.
In order to encode voice data, according to one exemplary embodiment of the invention a very robust method, referred to as continuous variable slope delta (CVSD) modulation, is used. CVSD is a type of delta modulation in which the incrementation of the approximated signal is continuously increased or reduced in order to adapt the approximated signal better to the analogue input signal. During the conversion, only the positive or negative changes compared to the previous value are indicated by means of a bit. CVSD usually operates with sampling rates of 32 kHz. However, implementations in alternative embodiments of the invention which operate with a low sampling rate are also possible.
   2. Asynchronous Connectionless (ACL) Connection Type:
Asynchronous connectionless communication provides a connectionless, packet-switching service.
An ACL communication link can be used whenever the channel is not reserved for an SCO communication link since, according to one exemplary embodiment of the invention, an SCO communication link has priority.
Between a master communication device and a slave communication device only one ACL communication link can be set up at any time. Within the scope of an ACL communication link it is possible for a master communication device also to transmit packets to all the slave communication devices which are in its piconet. This is also referred to as broadcasting. In this case, the master communication device simply does not insert a specific destination address for the data packet in the header field of the respective data packet (also referred to as packet head).
ACL communication links are designed for efficient data transmission. When the data is transmitted, the delay usually plays a subordinate role, while the data integrity is very important.
For the transmission of data it is possible to use data packets for one, three or five time slots. The payload is always protected by means of a checksum (except for in one specific type of packet which is not described in more detail here). For this reason, according to one exemplary embodiment of the invention Bluetooth also provides, in addition to the two methods for forward error correction, a method for automatic transmission repetition, referred to as an automatic repeat request method (ARQ method) in order to achieve reliable data transmission in this way.

While an SCO communication link is always symmetrical, i.e. the uplink channel and downlink channel have the same bandwidth (cf. Table 2), an ACL communication link can be operated both symmetrically and asymmetrically (cf. Table 3).

TABLE 2
overview of SCO links

| | | | | | Maximum |
|---|---|---|---|---|---|
| | Header | Useful data | | | symmetrical data |
| Type | [bytes] | [bytes] | FEC | CRC | rate [kbit/s] |
| HV1 | n.a. | 10 | ⅓ | Yes | 64.0 |
| HV2 | n.a. | 20 | ⅔ | Yes | 64.0 |
| HV3 | n.a. | 30 | No | Yes | 64.0 |
| DV | 1 D | 10+ (0-9) D | ⅔ D | Yes | 64.0 + 57.6 D |
| EV3 | n.a. | 1-30 | No | Yes | 96.0 |
| EV4 | n.a. | 1-120 | ⅔ | Yes | 192.0 |
| EV5 | n.a. | 1-180 | No | No | 288.0 |

TABLE 3
overview of ACL links

| | | | | | | Maximum | Maximum |
|---|---|---|---|---|---|---|---|
| | | | | | | asymmetrical data | asymmetrical data |
| | | | | | Maximum | rate | rate |
| | Header | Useful data | | | symmetrical data | (uplink) | (downlink) |
| Type | [bytes] | [bytes] | FEC | CRC | rate [kbit/s] | [kbit/s] | [kbit/s] |
| DM1 | 1 | 0-17 | ⅔ | Yes | 108.8 | 108.8 | 108.8 |
| DH1 | 1 | 0-27 | No | Yes | 172.8 | 172.8 | 172.8 |
| DM3 | 2 | 0-121 | ⅔ | Yes | 258.1 | 387.2 | 54.4 |
| DH3 | 2 | 0-183 | No | Yes | 390.4 | 585.6 | 86.4 |
| DM5 | 2 | 0-224 | ⅔ | Yes | 286.7 | 477.8 | 36.3 |
| DH5 | 2 | 0-339 | No | Yes | 433.9 | 723.2 | 57.6 |
| AUX1 | 1 | 0-29 | No | No | 185.6 | 185.6 | 185.5 |

Both types of connections, i.e. the SCO communication link and the ACL communication link use a time-division multiplex method for the duplex transmission of data.

Two information channels or more information channels can in this way be transmitted by means of the same communication link by allocating a different time interval (slot, also referred to as time slot) to each channel. For synchronous data packets it is possible to reserve specific time intervals, each data packet being transmitted at a different hop frequency. A data packet usually covers a single time interval, but can also occupy up to 5 slots.

The Bluetooth special interest group (Bluetooth SIG) committee which was entrusted with the standardization of the Bluetooth transmission technology defines both the physical transmission methods already described above and protocol layers, also application profiles, referred to as the Bluetooth profiles, which are intended to ensure that Bluetooth communication devices from different manufacturers cooperate with one another. The Bluetooth profiles can be used in any desired way in the exemplary embodiments of the invention. In one application profile, both rules and protocols can be defined for a dedicated application scenario. In many cases, an application profile can be understood as being a vertical section through the entire communication protocol layer model by virtue of the fact that it defines the obligatory communication protocol components for each communication protocol layer and/or defines application-profile-specific parameters for a specific communication protocol layer. In this way, a high degree of interoperability is ensured.

In addition, by using application profiles, the user has the advantage that he does not have to coordinate two communication terminals or a plurality of communication terminals with one another manually. In this way Bluetooth also permits a plurality of profiles at the same time.

Table 4 shows an overview of a number of Bluetooth application profiles which are currently provided and can be used in the exemplary embodiments. The certainly most important application profile is the generic access profile (GAP) with fundamental functions for communication link setup and for authenticating the other radio communication device or devices which participate in the communication, on which application profile all the other application profiles are usually based.

TABLE 4
Bluetooth profiles (selection)

| Abbreviation | Profile | Application |
|---|---|---|
| GAP | Generic access profile | Fundamental method |
| | | for authentication and |
| | | link setup |
| A2DP | Advanced audio | Wireless stereo link for |
| | distribution profile | loudspeakers or |
| | | headsets |
| SDAP | Service discovery | Service inquiry to |
| | application profile | currently visible |
| | | neighbors |
| CIP | Common ISDN access | ISDN-CAPI interface |
| | profile | |
| PAN | Personal area network | Network link to |
| | | Ethernet |
| SPP | Serial port profile | Serial interface |
| DUNP | Dial-up networking | Internet access |
| | profile | |
| CTP | Cordless telephony | Cordless telephony |
| | profile | |
| HSP | Headset profile | Cordless headset |
| HCRP | Hardcopy cable | Printing |
| | replacement profile | |
| HID | Human interface | Keyboard and mouse |
| | device | connection |
| | | (man/machine |
| | | interface) |
| GOEP | Generic object | Object exchange |
| | exchange profile | |
| HFP | Hands free profile | Manufacturer- |
| | | independent |
| | | communication |
| | | between mobile phone |
| | | and hands free device |
| FTP | File transfer profile | File transmission |
| BIP | Basic imaging profile | Image transmission |
| BPP | Basic printing profile | Printing |
| FaxP | Fax profile | Fax |
| IntP | Intercom profile | Radio telephony |
| PAN | Personal area network | Wireless connection to |
| | | Ethernet (LAN) |
| OPP | Object push profile | Transmitting deadlines |
| | | and addresses |
| SAP | SIM access profile | SIM card access |
| GAVDP | Generic AV | Audio and video |
| | distribution profile | transmission |
| AVRCP | Audio video remote | Audio/video remote |
| | control profile | control |
| ESDP | Extended service | Expanded service |
| | discovery profile | detection |
| SP | Synchronization profile | File synchronization |

For the sake of better understanding of the exemplary embodiments of the invention, the text which follows explains the ISO/OSI model, which represents a reference model for the description of manufacturer-independent communication systems which is standardized by the international organization for standardization (ISO) and is composed of seven layers. OSI means open system interconnection (open system for communication links).

The ISO/OSI model is used as an aid for describing open communication between different network communication devices from different manufacturers. A large number of freely usable network communication protocols are based on this reference model, a known example being the transport control protocol/Internet protocol (TCP/IP). The seven levels, in other words the seven communication protocol layers, are defined in such a way that they build on one another and each individual level can be used independently of the other levels.

The communication protocol layers which are defined by the OSI can be divided into two main groups: the communication protocol layers 1 to 4 constitute the transport system in which the communication channels are defined physically and logically. The levels, in other words the communication protocol layers, 5 to 7 constitute the application system and serve predominantly for representing information. The communication protocol layers are usually illustrated in such a way that the communication protocol layer 1 is represented graphically at the bottom and the communication protocol layer 7 at the top (cf. Table 5):

TABLE 5
the ISO layer model

| No. | English term | Examples |
|---|---|---|
| 7 | Application layer | Web browser, mail program |
| 6 | Presentation layer | HTML, XML, MIME |
| 5 | Session layer | http, FTP, POP3, SMTP |
| 4 | Transport layer | TCP |
| 3 | Network layer | IP |
| 2 | Data link layer | PPP |
| 1 | Physical layer | IEEE 802 |

In the text which follows, a number of main tasks of the respective communication protocol layers are described.

Communication Protocol Layer 7 (Application Layer):

The application layer produces the communication link between the user and one or more application programs, for example an e-mail application program or a data transmission application program, etc.
   Communication Protocol Layer 6 (Presentation Layer):
Data for the application layer are prepared in the presentation layer. The data is usually decoded, converted, encrypted or checked.
   Communication Protocol Layer 5 (Session Layer):
Services which serve to organize the transmission of data are prepared by means of the session layer. For example, communication links can be resumed again despite an intermediate interruption; to do this, for example, what are referred to as tokens are correspondingly inserted into the data packets.
   Communication Protocol Layer 4 (Transport Layer):
The transport layer provides the possibility of setting up and releasing communication links in an orderly way, of synchronizing communication links with one another and of distributing data packets along a plurality of communication links (also referred to as multiplexing). The transport layer connects the transport system to the application system of the ISO/OSI model (see above). Furthermore, data packets are segmented and packet congestion is prevented.
   Communication Protocol Layer 3 (Network Layer):

The network layer performs the switching and delivery of data packets. The compilation of routing tables and the routing per se also take place in the network layer. Packets which are to be forwarded are given a new intermediate destination address and do not penetrate into higher communication protocol layers. The connection between different network topologies is also made at this level, i.e. in this communication protocol layer.

Communication Protocol Layer 2 (Data Link Layer):

The data link layer organizes and monitors access to the transmission medium. The bit stream is segmented at the level of the data link layer and assembled into packets. Furthermore, data can be subjected to error checking, for example a checksum can be appended to a packet. It is also possible to compress the data in this communication protocol layer. Further components of the data link layer are sequence monitoring and monitoring of timing as well as flow control.

The data link layer can be divided once more into two sublayers. The “upper” sublayer is referred to as the logical link control sublayer (LLC layer) and the “lower” sublayer is referred to as the medium access control sublayer (MAC layer). The functionalities of the MAC layer can be expressed in different ways depending on the transmission medium (physical layer) used.

Their main functions usually include:
Detecting where data packets (frames) start and stop in the bit stream received from the physical layer (when data packets are received).
Dividing the data stream into data packets (frames) and possibly inserting additional bits into the data packet structure so that the start and the end of data packet can be detected in the receiver (when data packets are sent).
Detecting transmission errors, for example as a result of the insertion of a checksum during transmission or by means of corresponding control calculations during reception.
Insertion or evaluation of MAC addresses in the transmitter or receiver.
Access control, i.e. control to determine which of the communication devices accessing the physical medium has the right to transmit.
   Communication Protocol Layer 1 (Physical Layer):
   Plug-in connections, wavelengths and signal levels are defined in the physical layer. The bit sequences are converted into transmissible formats in this communication protocol layer. The properties of the transmission media (cable, radio, optical waveguides) are also defined in the physical layer.

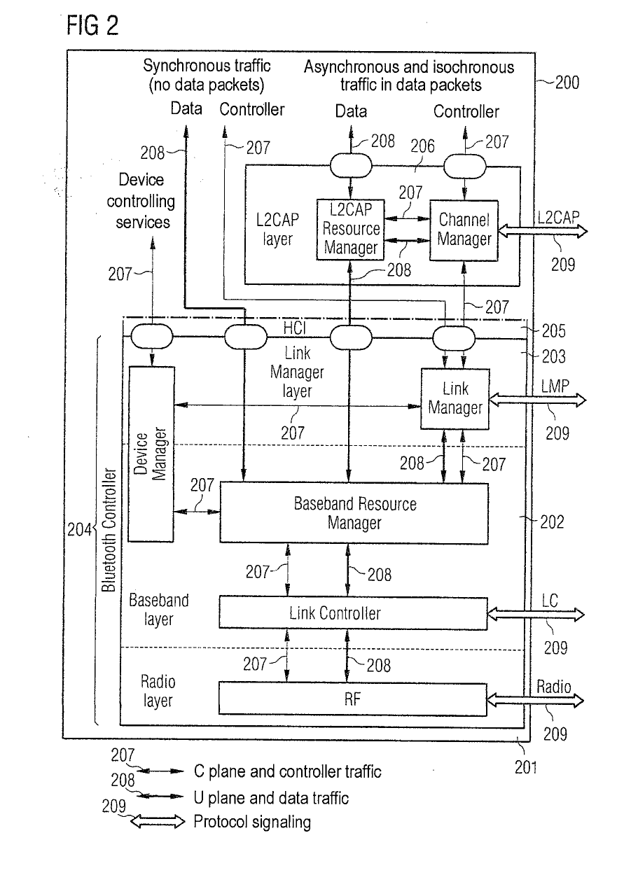

The lower protocol layers of the Bluetooth architecture according to one exemplary embodiment of the invention are illustrated in FIG. 2 in a protocol layer diagram 200.

The three lower communication protocol layers (physical layer, also referred to as radio layer 201 according to Bluetooth; data link layer, also referred to as baseband layer 202 according to Bluetooth, and the network layer, also referred to as link management layer 203 according to Bluetooth) are combined according to this exemplary embodiment of the invention to form a subsystem 204, which is also referred to as “Bluetooth controller”.

The transport layer above the Bluetooth controller 204 is terminated according to Bluetooth by the optional “host to controller interface” (HCI interface) 205 which is shown in FIG. 2. The HCI interface 205 serves as a service access point to the Bluetooth controller 204 in the Bluetooth architecture according to the exemplary embodiments of the invention.

Above the HCI interface 205 a session layer which is referred to as a logical link control and adaptation protocol layer 206 (L2CAP layer) is provided.

The L2CAP layer 206 is used, according to the exemplary embodiments of the invention, in ACL communication links but it is not used for SCO communication links which are aimed at ensuring an efficient voice transmission with a constant data rate of usually 64 kbit/s. According to the illustrated Bluetooth architecture, the strict division of the ISO/OSI model is not always complied with.

In the general Bluetooth architecture such as is provided according to the exemplary embodiments of the invention, parts of the network layer also extend into the transport layer. The presentation layer and the application layer are not shown in FIG. 2 for reasons of simpler illustration. Control signals 207 are represented in FIG. 2 by thin connecting arrows and form the control plane (C plane) while the data signals 208 are represented by thicker connecting arrows in FIG. 2, the data signals forming the user plane (U plane).

Interoperability in Bluetooth is ensured by the fact that on the one hand a clean interface is defined between the Bluetooth controller 204 (communication protocol layers extending downwards from the link management layer 203) and the “Bluetooth host” (the layers extending upwards from the L2CAP layer 206) within a Bluetooth communication system (specifically the HCI interface 205), and, on the other hand, the exchange of protocol messages between identical layers of two different Bluetooth communication systems is regulated unambiguously, symbolized in FIG. 2 by means of communication connecting arrows 209.

According to the exemplary embodiments of the invention there is provision to integrate both the proven physical transmission layer, which makes available data rates of up to 2.2 Mbit/s (net during downloading according to Bluetooth version 2.0 plus enhanced data rate), and in addition also one (or two) further physical transmission layers or these implementing units which have been proven in other fields of communication technology and provide significantly higher data rates of over 100 Mbit/s.

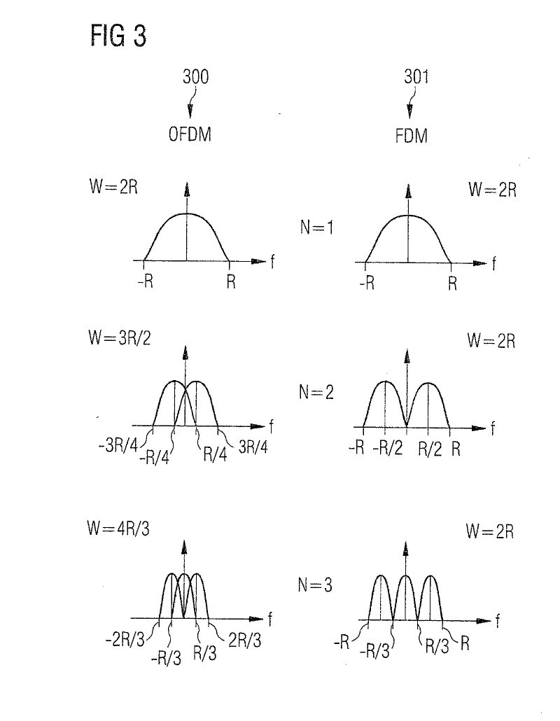

According to these exemplary embodiments of the invention, two alternative ultra wideband transmission technologies (UWB) are provided:
1. A transmission technology which is based on orthogonal frequency-division multiplexing (OFDM) according to the standard WiMedia alliance.
Known examples of the OFDM transmission technology are: digital video broadcasting (DVD), digital audio broadcasting (DAB), x digital subscriber line (xDSL) and power line communications (PLC).
The fundamental idea of OFDM, as in any other multicarrier system, is to transfer the initial problem of transmission of one (or more) broadband signals to the transmission of a set of narrow band signals which are orthogonal to one another so that the influences of the channel can be better modeled. Mathematically, two carrier signals are orthogonal to one another precisely if:

$${\int }_{0}^{T} {ⅇ}^{j2π {f}_{v} t} \cdot {ⅇ}^{- j2π {f}_{μ} t} ⅆ t = \{ \begin{matrix}const & v = μ \\ 0 & otherwise\end{matrix}$$
According to the OFDM transmission technology, a data stream is divided into N parallel relatively small component data streams and each of the N component data streams is transmitted on a separate subcarrier. The subcarriers are orthogonal to one another since specific frequency spacing is maintained. Spectral overlapping of the carriers is permitted since the orthogonality ensures the possibility of differentiation, and better spectral efficiency is achieved than with simple frequency-division multiplexing (FDM).
FIG. 3 shows the principle of OFDM transmission technology in the left-hand column 300, and the principle of FDM transmission technology in the right-hand column 301. FIG. 3 illustrates that a considerably smaller bandwidth is required using the OFDM transmission technology the greater the number of subcarriers that are used.
2. A solution which is based on a direct sequence spread spectrum transmission technology (DSSS) according to the standard of the UWB forum. DSSS is a frequency spread method for wireless data transmission in which an output signal is spread by means of a predefined sequence. With DSSS, the symbol energy is distributed over a large frequency bandwidth. For this purpose, the useful data stream is multiplied by a specific code whose data rate is higher than that of the useful data stream. This code sequence is referred to as chips or PN codes (pseudo-noise codes). The spread requires a relatively large frequency bandwidth to transmit the useful data stream. At the same time, however, the spectral power density is reduced so that the spread signal disappears virtually in the background noise and other signals are subject to less interference. The useful data stream can be reconstructed again at the receiver only by using the suitable chip sequence. DSSS has been used until now, for example, in the global positioning system (GPS) in a wireless local area network (WLAN) and in the mobile radio communication system Universal Mobile Telecommunications Systems (UMTS).
   The following example is used as the basis in the text which follows:
   chip sequence: 11000111

A bit is encoded by 8 chips—that is to say typically by means of an XOR logic operation (exclusive OR logic operation). The useful signal to be transmitted will be assumed to be the bit sequence “1 0”

signal: 10

| | |
|---|---|
| chip sequence: | 11000111 11000111 |
| XOR logic operation: | 00111000 11000111 |

The result of the exclusive OR operation would now be transmitted with a data rate which is higher by the factor 8. If the receiver knows the correct chip sequence and if it is synchronized with the received bit sequence, the original data can easily be recovered, as is represented below:

| | |
|---|---|
| received signal: | 00111000 11000111 |
| chip sequence: | 11000111 11000111 |
| XOR logic operation: | 11111111 00000000 |

The signal disappears in the background noise; in the original military application of this transmission technology use was made of the advantage that a potential attacker cannot readily detect that data is being transmitted at all. The longer the chip sequence, the greater the frequency bandwidth required to transmit a useful data stream of a predefined length.
A further property is utilized with what is referred to as the code division multiple access method (CDMA method): each transmitter is assigned a separate, uniquely defined chip sequence (also referred to as a pseudo-noise code). All the transmitters can then transmit simultaneously and the receiver can reconstruct the individual signals again and thus differentiate the transmitters.
DSSS is insensitive to narrow band interference since the interference signal is also multiplied at the receiver by the spread signal. In this way, the interference signal, like the useful data signal in the transmitter, is spread. The power density of the interference signal is reduced by the spread factor and can thus no longer disrupt the despread data signal. The useful data signal is multiplied in the receiver by the spread code for the second time, as provided, and is in this way despread again. In this case, the interference signal is submerged in the background noise.

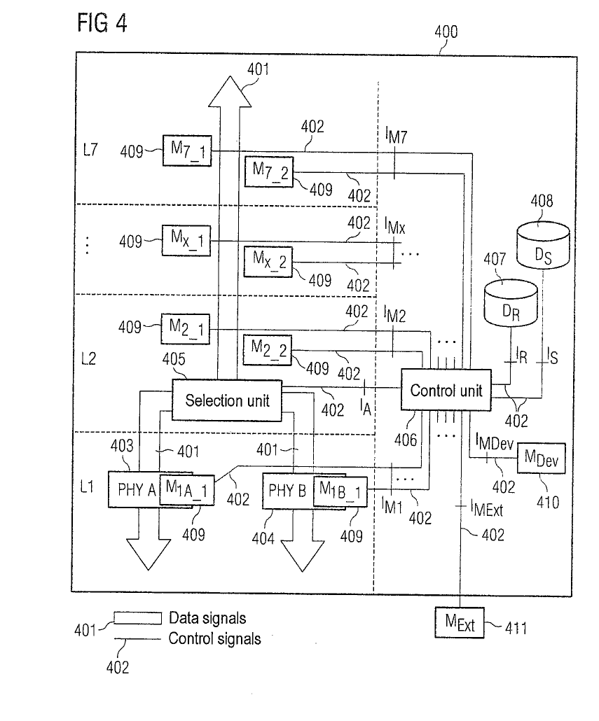

First, a simplified embodiment will be considered below in which the selection unit described below for selecting or switching over between two different physical layers, in other words between two different radio transmission technologies for Bluetooth is in the data link layer and can only select between two physical transmission technologies (in other words physical transmission techniques) as is illustrated in a block diagram 400 in FIG. 4.

FIG. 4 shows the units of the seven communication protocol layers L1, L2, . . . , L7 and the respective profile of the transmission of the respective signals, the data signal flow being symbolized by means of a broad arrow 401 and the control signal flow by means of normal continuous lines 402.

As is illustrated in FIG. 4, according to this exemplary embodiment of the invention a first physical layer radio transmission unit 403 and a second physical layer radio transmission unit 404 are provided in the physical layer L1.

In the second layer L2, i.e. in the data link layer, a selection unit 405 is provided which is configured to select one or more physical layer radio transmission units 403, 404 which are used to transmit data signals. Furthermore, a control unit 406 is provided which is connected to a first database D_{R} 407 and a second database D_{S} 408. The control unit 406 is additionally coupled to the selection unit 405 by means of an information interface I_{A}. Furthermore, measuring devices 409 are provided, with in each case two measuring devices 409 being provided in each communication protocol layer, as is also explained in more detail below. Furthermore, an equipment measuring device M_{Dev} 410, which is connected to the control unit 406 by means of an equipment interface I_{MDev}, is provided. An external measuring device interface with an external measuring device M_{Ext} 411 is also illustrated in FIG. 4.

Generally, the selection unit 405 can also be arranged in a higher communication protocol layer and can select, or switch on and off independently, via all the communication protocol layers located below it with more than two “data channels”. The term “data channel” is used within the scope of this description when the selection unit 405 is located in a higher communication protocol layer than the data link layer and refers to a communication link path through a plurality of communication protocol layers lying below the selection unit 405, including the physical layer which determines the configuration of this communication link path in a decisive way.

Different physical layers, and thus different radio transmission units 403, 404 (generally any desired number of radio transmission units) thus bring about a different configuration of such a communication link path.

According to the exemplary embodiments there is provision always to make available a satisfactory communication link irrespective of embodiment variants described in more detail below, in specific situations, for example when there is a risk of a collapse of a current communication link, when there is a rise in the quantity of data to be transmitted, when particular real-time requirements occur etc.

FIG. 4 shows, as has been described above, the ISO/OSI protocol layer model in the left-hand half, with each communication protocol layer having, for example, two measuring pickups, in other words two measuring devices (sensors) which supply measurement data to the control unit 406 when specific predefined events occur (this is also referred to as push mode), or are requested by the control unit 406 to carry out measuring operations and to transfer measurement information (this is also referred to as pull mode in the scope of this description).

The control unit 406 and the protocol-specific measuring pickups 409 are connected to one another by means of the connections I_{Mx} (x=1, 2, . . . , 7). The measuring pickups M_{Dev} 410, M_{Ext} 411 are also connected to the control unit 406 and according to these exemplary embodiments of the invention predominantly carry out protocol-independent measurements within or outside the radio communication device 101 and determine, for example, properties of the radio communication device (for example equipment properties) such as the battery charge state of a battery of the radio communication device, as well as, for example, can detect peripheral devices connected to the radio communication device or are provided for the connection of further external measuring pickups.

In the second database D_{S} 408 which is connected to the control unit 406, threshold values for comparison operations, which will be explained in more detail below, are stored. The first database D_{R} 407 includes at least one rule set for determining the selection information which is transmitted by means of the interface I_{A} from the control unit 406 to the selection unit 405. The rules can comprise, for example, an order ranking for efficient execution of comparison operations. Both databases 407, 408 are connected by means of links I_{S} and I_{R}, respectively, to the control unit 406. The exchange of data by means of the interfaces I_{S} and I_{R} is implemented bidirectionally, i.e. in both transmission directions, in accordance with the exemplary embodiments of the inventions, since it is possible to provide that threshold values and rules have to be adapted, in other words changed, by the control unit 406 during the operation of the radio communication device.

The control unit 406 can itself in turn have a comparison unit and a decision unit (not illustrated in detail in the figures for reasons of better clarity).

In the case of Bluetooth, there is provision for switching over to occur between two alternative MAC/PHY combinations in the data link layer L2 according to the exemplary embodiments of the invention described above.

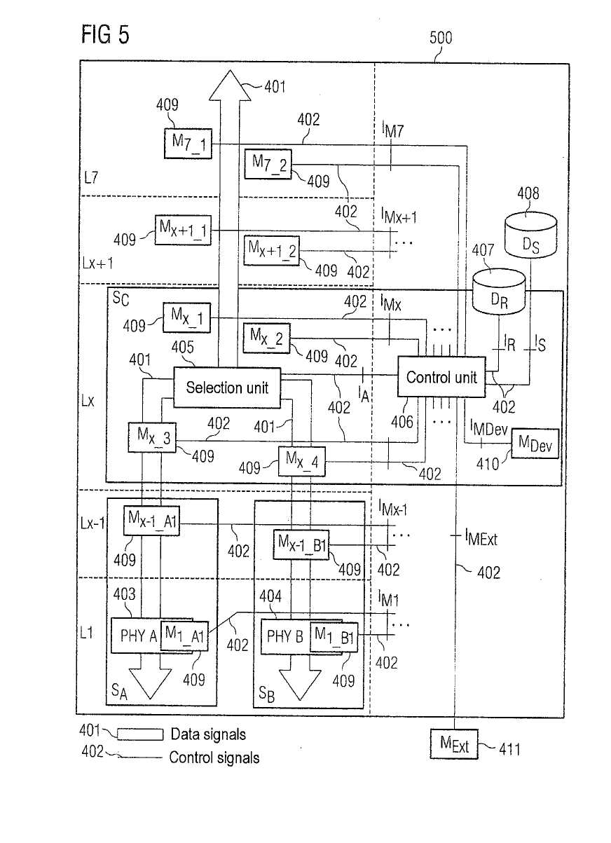

In one embodiment described below it is stated that the selection unit 405 can also be provided in another communication protocol layer located over, in other words above, the data link layer L2. Since the selection unit 405 can be provided in any of the communication protocol layers 3 to 6, by way of simplification only the communication protocol layer in which the selection unit 405 is provided is designated by Lₓ in a block diagram 500 in FIG. 5.

In yet another exemplary embodiment of the invention, the optional modules S_{A}, S_{B} and S_{C} which are illustrated in FIG. 5 are provided. A first module S_{A} represented, for example, a (conventional) Bluetooth module, for example a MAC/PHY combination including a separate RF part as part of the PHY_{A} element, for example the Bluetooth controller 204 illustrated in FIG. 2. A second module S_{B} contains, for example, an UWB module according to the OFDM communication standard of the WiMedia Alliance (likewise a MAC/PHY combination including a separate RF part as part of the PHY_{B} element). A third module S_{C} which contains the selection unit 405 contains a convergence layer which can be implemented, for example, by means of a processor, for example by means of a Pentium board. The databases D_{R} 407 and D_{S} 408 are, according to one exemplary embodiment of the invention, a component (entirely or partially) of a personal computer (not shown) in which the Pentium board is located.

All three modules can (as already explained above) contain one or more measuring pickups M 409 which either transmit protocol-specific measurement information regularly and/or sporadically, for example depending on the occurrence of specific predefined events, by means of a corresponding interface I_{Mx} (0<x<8, integer) to the control unit 406 or which can be called regularly and/or sporadically by the central control unit 406 to carry out measurements regularly and/or sporadically (for example when one or more specific predefined events occur) and to transmit the measurement information determined in the process to the control unit 406 by means of a corresponding interface I_{M}. The selection information is calculated in accordance with the explanations described above by reference to comparison values (threshold values) and rules (for example predefined efficient algorithms) which can be acquired from the databases D_{R} 407 and D_{S} 408.

The radio communication device which decides about the selection of the “data channel” to be used by the lower communication protocol layers, e.g. about the selection of the physical layer and thus of the radio transmission technology to be used, in other words the decision-making unit, can, according to one exemplary embodiment of the invention, be a master communication device, but in an alternative embodiment of the invention it can also be a slave communication device.

If necessary, the equipment involved, i.e. the communication devices involved, can themselves negotiate their distribution of roles. However, for example in piconets, it is advantageous if at first only the master communication device, in other words the communication device which initiates the communication link, decides, by means of a predefined basic setting, about the selection of the “data channel” to be used by the lower communication protocol layers.

The decision-making unit requires, for example, at least knowledge about the measured values which it has itself determined. In many cases it may be advantageous for the decision-making unit also to have knowledge about the measured values of the respective other radio communication device. The interface I_{MExt} 411 in the figures can, when necessary, be used for this functionality, i.e. in other words for exchanging the measured values between different radio communication devices or pieces of equipment/systems.

In an alternative embodiment of the invention, it is additionally provided for these tasks also to be performed by a dedicated application profile (a type of “measured value exchange profile”). In this case, it is also possible for the measuring pickups 409 distributed in the communication protocol layers of the system to be used for the functionality.

In an alternative embodiment of the invention, it is also provided in many cases for the threshold values and rules also to be transferred to the decision-making unit in addition to the measured values of the respective other radio communication device.

As an alternative to the transmission of measured values, threshold values and/or rule sets, it is possible for a radio communication device to suggest to its opposite party, in other words to the other party to the communication, a “data channel” also on the basis of its “local” knowledge (i.e. knowledge about its individual measured values, threshold values and/or rule sets), after which the other radio communication device either accepts or rejects the suggestion again on the basis of its “local” knowledge (i.e. knowledge about its individual measured values, threshold values and/or rule sets). Should the number of available “data channels” be greater than two, according to one exemplary embodiment of the invention it is provided for a sequence for the selection of a common “data channel” also to be transmitted to the other radio communication device. The transmission of such an order ranking (for example the following order ranking: “the first radio transmission technology PHY_{A} has priority; if not possible then the second radio transmission technology PHY_{B} is to be used, and if this is also not possible the third radio transmission technology PHY_{C} is to be used”) for the selection of a suitable “data channel” should not be restricted only to the time of the communication link setup here. The order ranking can be transmitted in any desired message and in any desired format to the respective decision-making radio communication device.

In the text which follows, four case examples for switching over or selecting radio transmission technologies are explained.

The case example which is illustrated below as case example number 4 with a battery which is becoming weaker in the radio communication device shows that renewed transmission of a sequence of “data channels” can also make sense in reaction to a changed initial condition.

The transmission of an order ranking constitutes a specific case of a general switch-over command (for example: “switch over to the second radio transmission technology of the physical layer PHY_{B}”) which is provided in an alternative embodiment of the invention.

According to different embodiments of the invention there is provision for a respective separate protocol or a new application profile to be defined between two radio communication devices for the ordered exchange of
a) measured values,
b) threshold values,
c) rule sets,
d) order rankings and/or
e) general switch-over switching commands.

In the text which follows, a number of possible scenarios are described in which switching over is provided between alternative “data channels” or the separate individual switching on and off of different “data channels” is provided. It is to be noted that the invention is not restricted to the case examples and scenarios described below but rather that it is possible to provide any scenarios in which switching over occurs between radio transmission technologies of the physical layer or in which a radio transmission technology is added to a radio transmission technology which is already being used within the scope of a communication link which has been set up.

### CASE EXAMPLE 1

### Communication Link Setup

If the two radio communication devices between which data, generally information, is to be transmitted, are still not connected to one another, i.e. between which there is still no communication link set up, according to one exemplary embodiment of the invention a communication link setup will be possible both via the first module S_{A} and via the second module S_{B}, in which case the details can be provided for negotiation according to the case example 3 described below.
If the communication link setup is restricted to just one type of communication link (for example conventional Bluetooth), it is possible, under certain circumstances, for the first type of communication link to block the communication link setup of the second type of communication link (for example UWB) even if (for example owing to a lack of signal field strength) a communication link setup were to be theoretically possible via the second type of communication link.

### CASE EXAMPLE 2

### Data Volume Which is Briefly Temporarily Increased

It is assumed that data transmission is already taking place using the first module S_{A} and a communication link is thus already set up between two radio communication devices, and that during the transmission of data measuring pickups detect that the requirement for frequency bandwidth will significantly rise (briefly) (for example a measuring pickup in the application layer signals:
“real time application demands high quality of service QoS”).
In this case, according to one exemplary embodiment of the invention there is provision for a supplementary or alternative data transmission to be initiated via the second module S_{B} and thus for a second radio data transmission technology to be used in a supplementary or alternative fashion if possible until the efficiency of the first module S_{A} is again sufficient to cope with the data transmission on its own.

### CASE EXAMPLE 3

### Change in Distance

Different physical transmission methods usually also have different characteristics such as, for example, transmission power and range.
According to this case example it is assumed that data transmission is already in operation via the first module S_{A} and thus a communication link is already set up between two radio communication devices. In addition it is assumed that owing to the increasing distance between the two participating radio communication devices an increasingly weak signal field strength occurs in the receiver communication device (for example a measuring pickup in the physical layer of a radio communication device signals: “out of range”).
In this case, according to one exemplary embodiment of the invention there is provision that an attempt is made by means of the second module S_{B} and by means of the second radio transmission technology which is implemented by the latter and which operates with a different transmission power and range to maintain the data transmission and thus maintain the communication link between the two radio communication devices.

### CASE EXAMPLE 4

### Weakening Battery

By means of measuring pickups which monitor the charge state of the battery of a radio communication device, for example of a mobile radio communication terminal, it is possible, for example, to restrict the data transmission via a first module S_{A} which has a high power demand, and instead to carry on via an alternative second module S_{B}, which has a low power consumption, as far as possible if it is necessary to save power (for example in this case a measuring pickup which is coupled to the battery and senses the charge state of the battery signals: “out of battery”).
If a radio communication device with a weakening battery is not identical to the decision-making party, there is provision, according to one exemplary embodiment of the invention, to transmit a “low battery indication” message or a “change PHY request” message to the decision-making party. A “low battery indication” message could then prompt the decision-making unit to change the radio transmission technology to be used on the physical layer, for example to a physical layer, in other words to a radio transmission unit whose power consumption is lower than with the physical layer which is currently being used, in other words with the radio transmission unit which is currently being used.
A “change PHY request” message can, for example, be brought about by transmitting a new priority list, as has been described above. In this case, there is provision for the priority of the physical layer with the lowest power consumption to be clearly characterized, for example by virtue of the fact that it is located at the first/uppermost position in the order ranking, in other words of the priority list.

The comparison operations carried out in the control unit 406 are explained in more detail below.

For the following considerations, without restriction of the general validity it is assumed that the selection unit 405 is in the second layer, i.e. in the data link layer.

As has been explained above, generalized embodiment variants were also provided in alternative embodiments of the invention in which the selection unit 405 is in a higher communication protocol layer (Lx where x>2) and consequently serves to switch on and off “data channels” which extend through a plurality of communication protocol layers below them, that is to say for example permits switching over between MAC_A/PHY_A and MAC_B/PHY_B, i.e. permits switching over between a respective combination of an MAC layer and a physical layer assigned to it (or between the modules S_{A} and S_{B} as illustrated in FIG. 5).

In one exemplary embodiment of the invention, a central role is assigned to the control unit 406. In that the selection information for switching on and off the different physical layers (i.e. the different radio transmission technology) or for switching over between the different physical layers (i.e. between the different radio transmission technologies) PHY_{A} and PHY_{B} is generated.

For example, this is done by carrying out comparison operations for which the following information is used:
measurement information from the measuring pickups M 409,
threshold values from the first database D_{S} 408,
priority rules/rule sets from the second database D_{R} 407.

The measuring pickups M 409 and the databases D_{S} 408 and D_{R} 407 (the two databases D_{S} 408 and D_{R} 407 can also be implemented in a common database) can be located entirely or partially within, for example, a radio communication device or in external units which can be connected to the radio communication device by means of a cable, by means of contacts or in a wireless fashion.

In an alternative embodiment of the invention there is also provision for the measuring pickups M 409 and the databases (also referred to as data memories) D_{S} 408 and D_{R} 407 to be stored, in the case of an external unit, on an intelligent memory card (referred to as a smart card), for example a SIM (Subscriber Identity Module) card or UICC (Universal Integrated Circuit Card) with an (U)SIM ((Universal) Subscriber Identity Module) which can be connected to the radio communication device (for example by the card being inserted into a mobile radio communication terminal as a radio communication device).

For example, it is advantageous to use intelligent memory cards such as are used in mobile radio because in them there are memory areas which can be written to or updated exclusively by the network operator and memory areas for which the user of the radio communication device has writing rights and reading rights. The areas of the memory which can be accessed only by the network operator on the respective smartcard are particularly suitable for storing and subsequent updating of data by means of the air interface (also referred to as updating “over the air”, OTA updating) of the network-operator-specific rules and threshold values.

According to one exemplary embodiment of the invention, for the execution of individual method steps or a plurality of method steps in a function unit which is independent of the radio communication device, it is provided for the executing control unit 406 to be embodied in the form of an application on a SIM card or on a UICC and to store or read out information by means of SAT (SIM application toolkit) or CAT or (U)SAT (CAT: card application toolkit or (U)SAT: USIM application toolkit).

The rule sets which are described in these exemplary embodiments and have efficient algorithms for calculating the selection information contain, for example, an order ranking for efficiently carrying out the comparison operations in order to be able to indicate a priority for the individual calculations to the control unit 406. In the examples such as have been explained above, the sequence of checking of the threshold values was selected randomly. Any other sequence is also possible. However, it is appropriate firstly to check the filter criterion which can be checked most quickly/most easily (i.e. with the least computational complexity) by the control unit 406. Furthermore it is appropriate to check last the filter criterion which makes complex computing operations in the control unit 406 necessary. According to one exemplary embodiment of the invention, there is provision on an individual case basis, and it is easier, to carry out a signal availability inquiry than to check a list of quality of service threshold values. This can vary from one application case to another. It is also advantageous to transfer measurement information to the control unit only if it is required to calculate the selection information.

As has been described above, the exemplary embodiments of the invention can be applied to any other desired radio access technologies (RAT), for example in alternative exemplary embodiments of the invention there is provision for the invention to be used for the following application case:

The first radio transmission technology is a transmission technology according to a wireless local area network communication standard, and the second radio transmission technology is a radio transmission technology according to a mobile radio communication standard, for example a third-generation mobile radio communication standard, for example according to the universal mobile telecommunications system communication standard (UMTS).

According to these exemplary embodiments of the invention, a method is provided for selecting at least one wireless access technology from a plurality of different wireless access technologies which are made available on the basis of a set of threshold values and a set of rules, for example of priority rules which are calculated by a unit within and/or outside a mobile radio communication terminal, for example a radio communication device, which is capable of being able to operate at least two different wireless access technologies. If the calculation takes place outside the radio communication device, that is to say for example in the network and if the databases D_{R} 408 and D_{S} 407 are located within the radio communication device, for example within a communication terminal (or on a storage medium which can be connected in a wire bound or cableless fashion to the radio communication device), the threshold values and rules which are calculated in the network, for example priority rules, are advantageously automatically delivered (also referred to as push) to the radio communication device for the purpose of updating the databases 407, 408 by means of a RAT air interface supported by the radio communication device.

In an alternative embodiment of the invention, the radio communication device can direct an inquiry to the unit in order to initiate the transmission of the calculated threshold values and rules, for example priority rules (also referred to as poll).

If databases D_{R} 407 and D_{S} 408 are themselves located outside the radio communication device (that is to say for example in the communication network), the radio communication device can direct an inquiry (if a comparison operation is to be carried out in the radio communication device) to the databases D_{R} 408 and D_{S} 407 in order to obtain knowledge about the current threshold values and rules, for example the priority rules, and about those which are to be used.

According to an exemplary embodiment of the invention it is assumed that an active WLAN communication link is present between a first radio communication device, set up in this case as a communication terminal, and a WLAN base station (PHY_{A}). In addition to the ability to set up a WLAN communication link, the communication terminal is at the same time able to operate a UMTS communication link (PHY_{B}).

With a WLAN communication link, the communication terminal can, according to the WLAN communication standard, request a priority class (for example DiffServ).

In a subsequent step, the WLAN access point can reserve resources (IntServ). Alternatively, the relevant WLAN quality of service parameters in the communication terminal can also be determined computationally by measurements and subsequent formation of average values. At the same time, the communication terminal can, according to the GPRS communication standard (“PDP context activation procedure”), negotiate a quality of service for a UMTS mobile radio communication link, i.e. as a reaction to a UMTS quality of service inquiry of the communication terminal the communication network in this case assigns to the communication terminal a specific UMTS quality of service which deviates frequently from the original request. Possible UMTS quality of service parameters are, for example: traffic class, maximum bit rate, ensured bit rate, bit error rate, maximum permissible transmission delay etc.

The quality of service (QoS) parameters such as are used in this exemplary embodiment of the invention cannot be acquired from a channel estimation (i.e. from the determination of the channel pulse response). The channel estimation specifically exclusively permits channel characteristics such as, for example, echoes, transit time differences and attenuation values to be determined. QoS parameters characterize the transmission channel in a different way.

The comparison operations described in this exemplary embodiment with threshold values can comprise, for example:
1. Changing only if the transmission power in the UMTS communication network is lower than the transmission power in the WLAN communication network when the QoS parameters are (approximately) the same.
2. Changing only if the quality of service in the UMTS communication network is better than in the WLAN communication network when the transmission power is (approximately) constant.
   or
3. Changing only if the data transmission in the UMTS communication network is not more expensive than in the WLAN communication network when the QoS parameters are (approximately) the same.
4. Changing only if the quality of service in the UMTS communication network is better than in the WLAN communication network when the costs are (approximately) the same.

The rules which are described in this exemplary embodiment for efficiently carrying out the comparison operations can comprise, for example:
“It is possible to dispense with a time-consuming and computationally intensive determination of the transmission powers in the two transmission systems. For an efficient decision a comparison of the relevant QoS parameters (within a cost class) is completely sufficient”.

For the purpose of easy updating it is advantageous to use a uniform, standardized structure for the two data sets, which can comprise the threshold values and rules, for example priority rules. For this purpose, according to the exemplary embodiments of the invention, the extensible markup language XML is used. This markup language is a document processing standard which is recommended officially by the World Wide Web consortium (W3C) both for dynamically generated contents and for static websites.

The XML format used according to these exemplary embodiments of the invention is particularly suitable for platform-independent and software-independent exchange of data between various programs and/or computers from different manufacturers. A further feature of XML is that the syntax of XML is relatively strict so that XML applications (i.e. definition of XML commands for a class of XML documents with the same structure, that is to say for a specific purpose) can be further processed substantially more easily, conveniently and efficiently by programs than, for example, HTML (Hypertext Markup Language) files.

An XML document generally has one or more XML elements. Each XML element has in each case two tags which are enclosed by large/small characters, an opening start tag which contains the name of the element, and a closing end tag which, apart from an oblique before the name, is identical to the start tag:

| Abstract: | Concrete: |
|---|---|
| <Name> | <Price> |
| Content | 24.95 |
| </Name> | </Price> |

The inclusion of specific attributes in an XML element is also possible:

| Abstract: | Concrete: |
|---|---|
| <Name attribute = ”value”> | <Price currency = ”Euro”> |
| Content | 24.95 |
| </Name> | </Price> |

In addition to “normal” XML documents, which are typically characterized by the use of informative XML elements, there are also XML documents of the DTD (document type definition) category for which rules have been specially agreed, as to how the XML elements and XML attributes which are used are defined, and the logic relationship they have with one another within the XML document.

To summarize, details are given below on a number of aspects of the exemplary embodiments of the invention:
A selection unit for the conditional selection of at least one “data channel” which is defined at least by the physical transmission medium is provided.
A control unit is provided which controls the selection unit by reference to measurement information and rule information.
A database with threshold values is provided.
A rule database is provided in which algorithms for efficiently comparing the measurement information with the threshold values are stored.
Internal measuring pickups are provided in at least one communication protocol layer of the ISO/OSI 7 layer reference model for determining measurement information (for example current properties of the transmission channels from the first communication protocol layer or general QoS requests for applications from the seventh communication protocol layer).
External measuring pickups are provided for determining external, i.e. non-protocol-specific values (for example signal transmitters when specific peripheral devices are connected or when specific predefined events occur).
According to one exemplary embodiment of the invention the following steps are provided:
   1. The measuring pickups distributed in the system supply regularly and/or sporadically (tied to specific events) internal and/or external measurement information to the control unit, or the control unit interrogates regularly and/or sporadically (tied to specific events) measurement information from the measuring pickup distributed in the system.
   2. The control unit uses the measurement information from the measuring pickups, the comparison values (=threshold values) acquired from the database and the efficient calculation rules, acquired from the rule database, to derive failure information. The calculated selection signals are transmitted to the selection unit.
   3. The selection unit switches on the basis of the selection information
      (a) the two alternative physical layers (i.e. the transmission technologies, also referred to as “transmission media”) on and off independently of one another, and/or
      (b) to and fro between at least two alternative “data channels” by means of the lower protocol layers (inclusive of the physical transmission media).
The units described above and the method steps described above for the next generation of the Bluetooth standard are used for separately and individually switching on and off (or switching over between) at least two alternative physical transmission paths.
An exemplary embodiment is provided in which a plurality of subsystems according to FIG. 5 are provided in the method, the three main components of the overall system being embodied as a conventional Bluetooth module (PHY_{A}, S_{A}), an ultra wideband module (PHY_{B}, S_{B}) based on an OFDM, and a convergence module (S_{C}), which can be a Pentium board, for example.
A method is provided for selecting or switching over between various physical layers, in other words between various radio transmission technologies, for a future generation of the Bluetooth technology.
The described exemplary embodiments of the invention permit dynamic distribution of the load over various transmission media (physical layers). Possible criteria for selecting/controlling/switching over are, for example, a change in the
   channel properties,
   equipment properties,
   external peripheral conditions,
   quality of service (QoS) requirements of the applications.
Calculating the selection information I_{A} taking into account the rules, for example priority rules, stored in the rule database D_{R} 408, significantly reduces the computational complexity and the power consumption in the control unit 406. Efficient computational algorithms are particularly significant for Bluetooth since the low power consumption of the Bluetooth technology acquires particular significance, for example also in the public relations work of the Bluetooth standardization committees.
The rules, for example the priority rules, are defined, for example by the fact that they link a plurality of different RATs to one another or permit a plurality of different RATs to be selected.
The threshold values and rules, for example priority rules, can also be calculated by a network unit outside the communication terminal and be transmitted, for the purpose of updating, to the databases D_{R} and D_{S} within a communication terminal.
The databases D_{R} and D_{S} with the threshold values or the rules, for example the priority rules, can also be located outside the communication terminal in the communication network, and the communication terminal can, for the purpose of updating, send requests for the transmission of the threshold values and/or rules, for example priority rules, to the databases D_{R} and D_{S}.

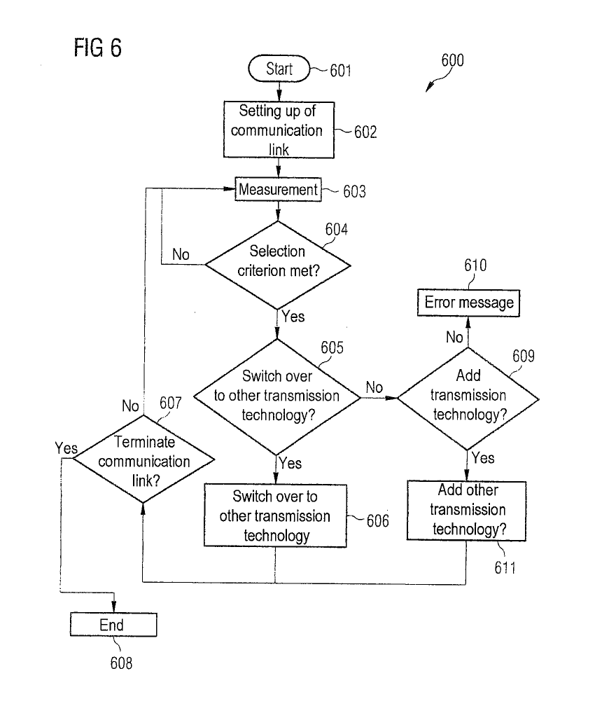

FIG. 6 also presents a number of method steps of the method according to an exemplary embodiment of the invention in order to summarize the exemplary embodiments of the invention in a flowchart 600.

After the method starts (step 601) a communication link is set up between a first radio communication device and a second radio communication device (step 602).

Subsequently, internal and/or external physical variables are measured or states are determined (step 603) while the communication link is set up and during the transmission of data between the radio communication devices, and it is checked whether a transmission technology selection criterion is met (first test step 604).

If the transmission technology selection criterion is not met (“no” in the first test step 604), the method is continued in the measurement step 603 and new measured values/states are determined.

However, if the transmission technology selection criterion is met (“yes” in the first test step 604), in a subsequent second test step 605 it is checked whether the system is to be switched over to another radio transmission technology owing to the selection criterion which has been met.

If this is the case (“yes” in the second test step 605), the system is switched over to the respective other desired radio transmission technology in the physical layer within the scope of the set-up communication link (step 606) and the method is continued in a further third test step 607 in which it is checked whether the communication link is to be ended. If this is the case (“yes” in the third test step 607), the communication link is ended and the method ends in an end step 608.

However, if the communication link is not yet to be ended (“no” in the third test step 607), the method is continued in step 603.

However, if, according to the second test step 605, the system is not to be switched over to another radio transmission technology (“no” in the second test step 605), in a fourth test step 609 it is checked whether the other transmission technology is to be also added as a transmission medium to the first radio transmission technology.

If this is not the case (“no” in the fourth test step 609), a fault message is output (step 610) and the method is ended.

However, if the other radio transmission technology is to be added (“yes” in the fourth test step 609), the other transmission technology is added to the currently present and used radio transmission technology (step 611), and the method is continued in the third test step 607.

What is claimed is:

1. A radio communication device comprising:
a first radio transmission unit for transmitting information according to a first radio close-range transmission technology;
a second radio transmission unit for transmitting information according to a second radio close-range transmission technology; and
a selection unit for selecting the first radio transmission unit or the second radio transmission unit or both radio transmission units for transmitting information depending on at least one predefinable radio transmission technology selection criterion.

2. The radio communication device as claimed in claim 1, wherein the selection unit is for selecting the first radio transmission unit or the second radio transmission unit or both radio transmission units for transmitting information depending on at least one predefinable, measured radio transmission technology selection criterion.

3. The radio communication device as claimed in claim 1, wherein at least one of the radio close-range transmission technologies is a radio access technology.

4. The radio communication device as claimed in claim 1, wherein at least one of the radio transmission units transmits information according to a radio close-range transmission technology with a radio transmission range of a maximum of 5 km.

5. The radio communication device as claimed in claim 1, wherein at least one of the radio transmission units transmits information according to a radio close-range transmission technology with a radio transmission range of a maximum of 2 km.

6. The radio communication device as claimed in claim 1, wherein at least one of the radio transmission units transmits information according to a Bluetooth transmission technology.

7. The radio communication device as claimed in claim 1, wherein at least one of the radio transmission units transmits information according to a transmission technology selected from the group consisting of Bluetooth physical communication layer transmission technology, frequency-division multiplex, time-division multiplex, broadband radio close-range transmission technology, and ultra wideband radio close-range transmission technology.

8. The radio communication device as claimed in claim 1, wherein at least one of the radio transmission units transmits information according to one of the transmission technologies selected from the group consisting of orthogonal frequency-division multiple access and frequency spread method.

9. The radio communication device as claimed in claim 1, wherein the radio transmission unit is a unit of the physical communication layer.

10. The radio communication device as claimed in claim 1, wherein the selection unit is a unit of a communication layer which is higher than the physical layer.

11. The radio communication device as claimed in claim 10, wherein the selection unit is a unit of a communication layer selected from the group consisting of data link layer, transport layer, network layer, and switching layer.

12. The radio communication device as claimed in claim 1, wherein the selection unit dynamically distributes the information over a plurality of radio transmission units, while at least one radio communication link is set up using a radio close-range transmission technology.

13. The radio communication device as claimed in claim 1, wherein the predefinable radio transmission technology selection criterion is selected from the group consisting of a criterion which describes properties of a channel, a criterion which describes properties of the radio communication device, a criterion which describes properties outside the radio communication device, and a criterion which describes requirements of an application for which the information is to be transmitted.

14. The radio communication device as claimed in claim 1, wherein the predefinable radio transmission technology selection criterion is a criteria selected from the group consisting of a criterion which describes properties of a physical channel, a criterion which describes properties of a transport channel, and a criterion which describes properties of a logic channel.

15. The radio communication device as claimed in claim 1, wherein the predefinable radio transmission technology selection criterion is a predefined battery charge state of a battery of the radio communication device.

16. The radio communication device as claimed in claim 1, wherein the predefinable radio transmission technology selection criterion is a criterion selected from the group consisting of a predefined speed with which the radio communication device is moved, and a connection of at least one device to the radio communication device.

17. The radio communication device as claimed in claim 1, further comprising a rule memory for storing at least one rule according to which the at least one radio close-range transmission technology is selected.

18. The radio communication device as claimed in claim 1, further comprising at least one measuring device for measuring physical quantities whose values are to be compared with the predefinable radio transmission technology selection criterion.

19. The radio communication device as claimed in claim 18, further comprising a plurality of measuring devices for measuring physical variables whose values are to be compared with the predefinable radio transmission technology selection criterion.

20. The radio communication device as claimed in claim 19, wherein the measuring devices are provided at least partially in different communication layers.

21. The radio communication device as claimed in claim 20, wherein at least one measuring device measuring information from the respective communication layer is provided in each of the following communication layers: physical layer, data link layer, transport layer, and switching layer.

22. The radio communication device as claimed in claim 1, further comprising at least one control unit controlling the at least one measuring device.

23. The radio communication device as claimed in claim 1, wherein the selection unit, while a radio communication link is set up, switches over to at least one other radio close-range transmission technology.

24. A radio communication arrangement comprising:
at least one radio communication device as claimed in claim 1; and
a rule database for storing at least one rule according to which the at least one radio close-range transmission technology in the radio communication device is selected.

25. A method for transmitting information, comprising selecting at least one radio close-range transmission technology from a plurality of radio close-range transmission technologies for transmitting information from a first radio communication device to a second radio communication device depending on at least one predefinable radio transmission technology selection criterion.

26. The method as claimed in claim 25, further comprising transmitting information according to the selected radio close-range transmission technology.

27. The method as claimed in claim 25, further comprising:
transmitting information according to a first radio close-range transmission technology;
selecting at least one second radio close-range transmission technology from a plurality of radio close-range transmission technologies for transmitting information depending on at least the predefinable radio transmission technology selection criterion; and
transmitting information according to the first radio close-range transmission technology or the second radio close-range transmission technology, or both.

28. A computer program product for transmitting information during execution using a processor, comprising selecting at least one radio close-range transmission technology from a plurality of radio close-range transmission technologies for transmitting information from a first radio communication device to a second radio communication device depending on at least one predefinable radio transmission technology selection criterion.

29. A radio communication device comprising:
a first radio transmission unit for transmitting information according to a first radio close-range transmission technology;
a second radio transmission unit for transmitting information according to a second radio close-range transmission technology; and
a selection unit for selecting the first radio transmission unit or the second radio transmission unit or both radio transmission units for transmitting information depending on a predefined battery charge state of a battery of the radio communication device.

30. A method for transmitting information in a radio communication system, comprising:
setting up a communication link between a first radio device and a second radio device using a first radio transmission technology; and
determining, based on a transmission technology selection criteria, whether the system is to be switched to a second radio transmission technology.

31. The method as claimed in claim 30, further comprising determining whether the second transmission technology is to be added as a transmission medium to the first radio transmission technology.

32. A radio communication device comprising:
a first radio transmission unit for transmitting information according to a first radio close-range transmission technology;
a second radio transmission unit for transmitting information according to a second radio close-range transmission technology; and
a selection means for selecting the first radio transmission unit or the second radio transmission unit or both radio transmission units for transmitting information depending on at least one predefinable radio transmission technology selection criterion.
